(19) United States
(12) Patent Application Publication
(10) Pub. No.: US 2024/0239723 A1
(43) Pub. Date: Jul. 18, 2024

(54) GAS GENERATOR AND GAS DISCHARGE METHOD

(71) Applicant: Daicel Corporation, Osaka (JP)

(72) Inventor: Tomoya SASAKI, Tokyo (JP)

(73) Assignee: Daicel Corporation, Osaka (JP)

(21) Appl. No.: 18/562,351

(22) PCT Filed: Dec. 28, 2021
(86) PCT No.: PCT/JP2021/048950

§ 371 Date: Nov. 20, 2023

(30) Foreign Application Priority Data
May 21, 2021 (JP) 2021-086440
Sep. 22, 2021 (JP) 2021-154784

(51) Int. Cl. B60R 21/264; B60R 21/217; B60R 21/26

(52) U.S. Cl. CPC B60R 21/2644; B60R 21/2171; B60R 2021/2177; B60R 2021/26011; B60R 2021/26029

(57) ABSTRACT

A gas generator includes: an ignition device attached to one end side of a housing; a combustion chamber formed inside the housing and configured to accommodate a gas generating agent; a diffuser portion in a cup shape formed on the other end side of the housing and including a plurality of gas discharge ports; a filter at least partially accommodated inside the diffuser portion, the filter internally including a hollow flow path directed from an open end side toward a closed end side of the diffuser portion, the flow path including a first section including one end connected to the combustion chamber and a second section connected to the other end of the first section; and a block portion configured to bring a communication state between the first section and the second section when the combustion pressure is equal to or greater than the critical threshold.

### TECHNICAL FIELD

The present invention relates to a gas generator and a gas discharge method.

### BACKGROUND ART

In the related art, there has been proposed a gas generator including: a long cylindrical metal housing body; a metal holder to which an igniter is assembled; and a bottomed tubular storage chamber defining member defining a gas generating agent storage chamber in which a gas generating agent is stored (e.g., Patent Document 1). When a gas generated by combustion of a gas generating agent passes through a filter, the technique functions as a cooling portion for cooling the gas by removing high temperature heat of the gas, and also functions as a removal portion for removing slag (residues) and the like contained in the gas. The housing body of the part defining the filter chamber is provided with a plurality of gas discharge ports along the circumferential direction and the axial direction. The gas discharge port leads the gas after passing through the filter to the outside of the housing.

There has also been proposed a cylinder type gas generator including: a housing including a long bottomed cylindrical first housing member, an igniter, a partition plate, a dividing member, a transfer charge, a gas generating agent, and a filter (e.g., Patent Document 2). The dividing member is constituted of a bottomed cylindrical member arranged in an operation gas generating chamber, and includes a cylindrical part, a bottom part, a first communication hole, and a hollow part. The gas generating agent is stored in a portion except the hollow part of the operation gas generating chamber. A force directed outward in the radial direction of the housing is applied to the partition plate due to the internal pressure during operation, and the movement of the partition plate is suppressed.

### CITATION LIST

### Patent Documents

Patent Document 1: JP 2017-193192 A
Patent Document 2: JP 2010-260387 A

### SUMMARY OF INVENTION

### Technical Problem

In general, output of a gas generator varies depending on the environmental temperature during operation. That is, when the environmental temperature increases, the combustion speed of the gas generating agent increases, and even in a gas generator of the same specifications, the temperature of the combustion gas output during operation tends to be high in a high-temperature environment.

A technique of the present disclosure is to provide a technique for reducing a difference in output due to a difference in environmental temperature in a gas generator.

When a gap is generated between the filter and the housing in the gas generator, there is a possibility that a short path occurs in which the generated combustion gas is discharged from the gas discharge port of the housing without passing through the filter. For example, the occurrence of a short path can be suppressed by performing full circumference welding without a gap, but it takes time and effort in the manufacturing process. Therefore, instead of or in addition to the above object, an object of the technique of the present disclosure may be to suppress occurrence of a short path with a simple configuration.

### Solution to Problem

A gas generator of the present disclosure includes: a housing forming an outer shell container and extending from one end side to the other end side: an ignition device attached to the housing: a combustion chamber formed inside the housing and configured to accommodate a gas generating agent ignited by the ignition device: a diffuser portion in a cup shape provided on the other end side of the housing and including a closed end with an end part being closed and a side wall including a plurality of gas discharge ports; a filter at least partially accommodated inside the diffuser portion, the filter internally including a hollow flow path directed from a side of the combustion chamber to a side of the closed end, the flow path including a first section including one end connected to the combustion chamber, and a second section connected to the other end of the first section; and a block portion configured to bring a closed state between the first section and the second section when a combustion pressure of the gas generating agent during operation is less than a predetermined critical threshold, and configured to bring a communication state between the first section and the second section when the combustion pressure is equal to or greater than the critical threshold. The side wall of the diffuser portion includes a first side wall region positioned around the first section and a second side wall region positioned around the second section, and each of the first side wall region and the second side wall region is provided with one or more of the plurality of gas discharge ports.

In the gas generator of the present disclosure, the block portion can switch between the first section and the second section in the filter into the closed state or the communication state depending on the internal pressure of the combustion chamber. In the diffuser portion, one or more gas discharge ports are provided in each of a first side wall region positioned around the first section and a second side wall region positioned around the second section. Therefore, the part of the filter through which the combustion gas discharged from the gas discharge port passes can be switched depending on the internal pressure of the combustion chamber. Since the block portion brings between the first section and the second section into a closed state when a combustion pressure of the gas generating agent during operation is less than a predetermined critical threshold, and brings the first section and the second section into a communication state when the combustion pressure is equal to or greater than the critical threshold, the region of the filter through which the combustion gas circulates can be enlarged when the environmental temperature is high and the internal pressure of the combustion chamber is great, and the cooling efficiency can be improved. On the other hand, when the environmental temperature is low and the internal pressure of the combustion chamber is low, the region of the filter through which the combustion gas circulates is reduced and the cooling is suppressed. While the output of the gas generator is affected by the environmental temperature, according to the gas generator of the present disclosure, the difference in the output due to the difference in the environmental temperature can be reduced.

The filter may include the second section with an inner diameter smaller than an inner diameter of the first section, and a step portion at a boundary between the first section and the second section: the block portion may close between the combustion chamber and the first section before operation, have a diameter equal to or smaller than the inner diameter of the first section and larger than the inner diameter of the second section, and include a rupture portion formed to be punched out at a pressure equal to or greater than an operation threshold less than the critical threshold: when the combustion pressure is equal to or greater than the operation threshold and less than a critical threshold, the rupture portion may be punched out by the combustion pressure and moved to the step portion to close a space between the first section and the second section; and when the combustion pressure further reaches the critical threshold or greater, at least a part of the rupture portion may be moved to the second section beyond the step portion by the combustion pressure, and bring a communication state between the first section and the second section.

The filter may include the second section with an inner diameter smaller than an inner diameter of the first section, and a step portion at a boundary between the first section and the second section: the block portion may close between the combustion chamber and the first section before operation, have a diameter equal to or smaller than the inner diameter of the first section and larger than the inner diameter of the second section, and include a rupture portion formed to be punched out at a pressure equal to or greater than an operation threshold less than the critical threshold; the rupture portion may have a through hole and a seal member configured to close the through hole and be ruptured at a pressure equal to or greater than the critical threshold; when the combustion pressure is equal to or greater than the operation threshold and less than a critical threshold, the rupture portion may be punched out by the combustion pressure and moved to the step portion to close a space between the first section and the second section; and when the combustion pressure further reaches the critical threshold or greater, the seal member may be ruptured by the combustion pressure to open the through hole, and brings a communication state between the first section and the second section.

The block portion may include: a first block member configured to close between the combustion chamber and the first section before operation, and causes the combustion chamber with the first section to communicate when the combustion pressure is equal to or greater than an operation threshold less than the critical threshold and less than the critical threshold; and a second block member that closes between the first section and the second section before operation, and causes the first section and the second section to communicate when the combustion pressure is equal to or greater than the critical threshold.

The block portion may include a seal member configured to close the gas discharge port provided in the first side wall region before operation, and be ruptured when the combustion pressure is equal to or greater than an operation threshold less than the critical threshold and less than the critical threshold, and a block member configured to close between the first section and the second section before operation, and causes the first section and the second section to communicate when the combustion pressure is equal to or greater than the critical threshold.

The block portion may include a fragile part in which the block portion is thinned along the shape of the rupture portion. This makes it easy to punch the rupture portion as intended.

The total opening area of the gas discharge ports provided in the second side wall region may be larger than the total opening area of the gas discharge ports provided in the first side wall region. When the gas generator has a plurality of gas discharge ports, the amount of combustion gas discharged from each of the gas discharge ports per unit time varies depending on the area of the gas discharge port. By increasing the total opening area of the gas discharge ports provided in the radial direction around the second section positioned on the closed end side of the diffuser portion, a large amount of combustion gas can be caused to circulate through a part of the filter on the closed end side of the diffuser portion, and the cooling efficiency of the entire combustion gas discharged from the gas discharge ports can be improved.

A gas discharge method according to the present disclosure includes supplying an ignition current to ignite the ignition device and combusting the gas generating agent and bringing between the first section and the second section into a closed state with the block portion when the combustion pressure is less than a predetermined critical threshold, and bringing between the first section and the second section into a communication state when the combustion pressure is equal to or greater than the critical threshold.

A gas generator of the present disclosure according to the other aspect includes a housing in a tubular shape forming an outer shell container and extending from one end side to the other end side an ignition device attached to the housing: a combustion chamber formed inside the housing and configured to accommodate a gas generating agent ignited by the ignition device: a diffuser portion in a tubular shape inserted into the one end side of the housing and having a gas discharge port; and a filter including a body portion accommodated in the diffuser portion and a flange portion protruding in the radial direction outward relative to an inner periphery of the diffuser portion at an end portion of the body portion on the housing side, in which a first annular surface of a surface of the flange portion, the first annular surface facing the body portion side, comes into contact with an end part of the diffuser portion on the housing side.

The gap between the diffuser portion and the filter can be closed to bring the flange portion of the filter into contact with the end part of the diffuser portion inserted into the housing. Therefore, the combustion gas generated by the gas generating agent is suppressed from passing through between the diffuser portion and the filter and being discharged from the gas discharge port without passing through the filter. That is, the occurrence of a short path can be suppressed with a simple configuration.

The flange portion may include a second annular surface facing the back side of the first annular surface and an annular peripheral surface connecting the first annular surface and the second annular surface, and the annular peripheral surface may come into contact with an inner periphery of the housing. Also by bringing the annular peripheral surface of the flange portion and the inner periphery of the housing into contact with each other, a short path of the combustion gas can be prevented, and thus the combustion gas can be suppressed from being discharged from the gas discharge port without passing through the filter.

The body portion of the filter may include a recess portion extending along an axial direction of the diffuser portion from the housing side, and the housing portion may internally include an orifice plate partitioning the combustion chamber and the recess portion and having a through hole causing the combustion chamber and the recess portion to communicate. The combustion chamber and the filter can be partitioned in this manner, for example.

The outer diameter of the orifice plate may be smaller than the outer diameter of the flange portion, and the outer peripheral part of the second annular surface of the flange portion may be exposed to the housing side. This provides a configuration in which the combustion gas can be introduced into the filter also from the outer peripheral part of the flange portion.

The diffuser portion may have a closed end with an end part being closed on an opposite side to the housing, and the filter may come into contact with the closed end, the recess portion of the filter may be a through hole, and a thickness of the filter may be thicker on the closed end side than on the housing side. The combustion gas having collided with the closed end of the diffuser portion passes through a filter present in the vicinity thereof and is discharged from the gas discharge port. In particular, a relatively large amount of combustion gas having an increased flow speed after passing through the orifice plate reaches the closed end of the diffuser portion, passes through the filter in the vicinity thereof, and is discharged from the gas discharge port. By increasing the thickness of the filter on the closed end side as described above, the cooling performance on the closed end side of the filter can be improved.

The ignition device may be attached to the other end side of the housing, a retainer that partitions a space in which the ignition device is disposed and the combustion chamber and has an opening may be included, the retainer holding the gas generating agent in the combustion chamber, and the retainer may have a flat plate portion supporting the gas generating agent, a connection portion provided on an outer periphery of the flat plate portion and coming into contact with an inner periphery of the housing, and a through hole in a peripheral edge portion of the flat plate portion. While a gap extending relatively linearly toward the diffuser portion is formed between the gas generating agent and the inner periphery of the housing, the combustion gas having passed through the through hole provided in the peripheral edge portion of the flat plate portion easily flows in the axial direction of the housing along the inner periphery of the housing.

The ignition device may be attached to the other end side of the housing, a retainer that partitions a space in which the ignition device is disposed and the combustion chamber and has an opening may be included, the retainer holding the gas generating agent in the combustion chamber, and the retainer may have a flat plate portion supporting the gas generating agent, a step portion provided along an outer periphery of the flat plate portion separately from an inner periphery of the housing, and a connection portion coming into contact with the inner periphery of the housing, and a through hole in the step portion. While a gap extending relatively linearly toward the diffuser portion is formed between the gas generating agent and the inner periphery of the housing, the combustion gas having passed through the through hole provided in the step portion of the retainer provided along the outer periphery of the flat plate portion passes through the retainer toward the inner periphery of the housing, and easily flows in the axial direction of the housing along the inner periphery of the housing.

The ignition device may be attached to the other end side of the housing, a retainer that partitions a space in which the ignition device is disposed and the combustion chamber and has an opening may be included, the retainer holding the gas generating agent in the combustion chamber, and the retainer may have a flat plate portion having an outer diameter smaller than an inner diameter of the housing and supporting the gas generating agent, a connection portion coming into contact with an inner periphery of the housing, an annular inclined surface tapered from an outer periphery of the flat plate portion to the connection portion, and a through hole in the annular inclined surface. While a gap extending relatively linearly toward the diffuser portion is formed between the gas generating agent and the inner periphery of the housing, the combustion gas having passed through the through hole provided in the annular peripheral surface tapered from the outer periphery of the flat plate portion passes through the retainer toward the inner periphery of the housing, and easily flows in the axial direction of the housing along the inner periphery of the housing.

### Advantageous Effects of Invention

According to the present disclosure, a technique for reducing a difference in output due to a difference in environmental temperature can be provided in a gas generator.

### BRIEF DESCRIPTION OF DRAWINGS

FIG. 1 is a schematic axial cross-sectional view illustrating an example of a gas generator according to an embodiment.

FIG. 2 is a partial cross-sectional view indicating a diffuser portion and a periphery thereof.

FIG. 3 is a plan view of a block member as viewed from the diffuser portion side.

FIG. 4 is a partial cross-sectional view illustrating an example of a state where the block member is ruptured and the first portion is moved.

FIG. 5 is a partial cross-sectional view illustrating an example of a state where the first portion of the block member is further ruptured.

FIG. 6 is a view schematically illustrating a flow of combustion gas in the example of FIG. 4.

FIG. 7 is a view schematically illustrating a flow of combustion gas in the example of FIG. 5.

FIG. 8 is a partial schematic axial cross-sectional view illustrating an example of a gas generator according to a second embodiment.

FIG. 9 is a partial cross-sectional view illustrating an example of a state where the block portion is ruptured and the first portion is moved.

FIG. 10 is a partial cross-sectional view illustrating an example of a state where a seal tape further is ruptured.

FIG. 11 is a partial schematic axial cross-sectional view illustrating an example of a gas generator according to a third embodiment.

FIG. 12 is a partial schematic axial cross-sectional view illustrating an example of a gas generator according to a fourth embodiment.

FIG. 13 is a schematic axial cross-sectional view illustrating an example of a gas generation device according to another embodiment.

FIG. 14 is a partial cross-sectional view indicating the diffuser portion and a periphery thereof.

FIG. 15 is a schematic view for explaining a movement path of the combustion gas in the diffuser portion.

FIG. 16 is a schematic view for explaining a movement path of the combustion gas in the combustion chamber.

FIG. 17 is a schematic axial cross-sectional view illustrating an example of a gas generation device according to a sixth embodiment that is a variation of a fifth embodiment.

FIG. 18 is a schematic axial cross-sectional view illustrating an example of a gas generation device according to a seventh embodiment that is a variation of the fifth embodiment.

### DESCRIPTION OF EMBODIMENTS

Embodiments according to the present disclosure will be described below with reference to the accompanying drawings. It should be noted that the respective configurations and the combinations thereof in the respective embodiments are mere examples, and the configurations can be added, omitted, substituted, and differently modified as appropriate within a scope not departing from the spirit of the present invention. The present disclosure is not limited by the embodiment and is limited only by the claims.

### First Embodiment

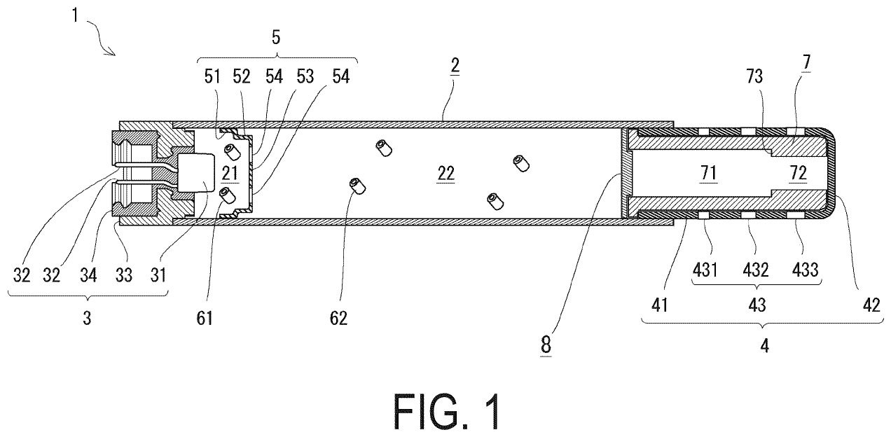

FIG. 1 is a schematic axial cross-sectional view illustrating an example of the gas generator according to the present embodiment. A gas generator 1 can be used as a gas generation device for inflating an airbag, for example. The gas generator 1 of FIG. 1 includes a tubular housing 2, an ignition device 3 attached to one axial end side of the housing 2, and a diffuser portion 4 formed on the other end side of the housing 2.

The ignition device 3 is a device that ignites with an ignition current, and is the same as one used in a known gas generator. For example, the ignition device 3 has a metal cup body 31 accommodating an ignition charge and sealed, and a pair of electro-conductive pins 32 and 32 for receiving supply of a current from the outside, and these are fixed to a metal igniter holding portion 33 with a resin member 34. The igniter holding portion 33 of the ignition device 3 is attached to an opening on one axial end side of the housing 2 by, for example, full circumference welding. The full circumference welding is annular welding that is continuous in the circumferential direction, and refers to a state where two members of welding targets are closed without a gap.

The housing 2 is, for example, a tubular member having a substantially uniform inner diameter and outer diameter, and forms an outer shell container of the gas generator 1. The material of the housing 2 is, for example, metal. A partition wall 5 in a cup shape is disposed inside the housing 2 at a predetermined distance away from the ignition device 3.

In other words, the partition wall 5 is a bottomed tubular member with the side part including a large diameter part 51 having a large diameter and a small diameter part 52 having a small diameter. The outer diameter of the large diameter part 51 of the partition wall 5 is substantially the same as the inner diameter of the housing 2. Therefore, the housing 2 can accommodate the partition wall 5 and thus a bottom part 53 is positioned on the diffuser portion 4 side. The housing 2 and the outer periphery of the large diameter part 51 may be welded, or may be connected by engagement portions (not illustrated) such as recesses and protrusions that are engaged with each other and provided on the inner periphery of the housing 2 and the outer periphery of the large diameter part 51. At least one through hole 54 having a predetermined shape is formed in the bottom part 53 of the partition wall 5. The through hole 54 allows a combustion product of a gas generating agent described later to pass therethrough. A through hole may also be provided in a side part in the small diameter part 52 of the partition wall 5. The partition wall 5 partitions an internal space of the housing 2 into a first combustion chamber 21 (also called an “enhancer chamber”) formed between the ignition device 3 and the partition wall 5 and a second combustion chamber 22 formed between the partition wall 5 and the diffuser portion. The side part (the large diameter part 51 or the small diameter part 52) of the partition wall 5 may be extended to such an extent that the partition wall 5 and the ignition device 3 come into contact with each other, and the first combustion chamber 21 may be formed by the partition wall 5 and the ignition device 3.

The first combustion chamber 21 accommodates a first gas generating agent 61 (also called “transfer charge” or “enhancer agent”). The second combustion chamber 22 accommodates a second gas generating agent 62. The gas generating agent (the first gas generating agent 61 and the second gas generating agent 62) includes a known composition formed of, for example, guanidine nitrate (41 wt. %), basic copper nitrate (49 wt. %), a binder, or an additive. As the individual shape of the gas generating agent, for example, a pellet shape, a disk shape, a columnar shape, or a single-hole columnar shape having a through hole can be used. However, the gas generating agent is not limited to those described above. The first gas generating agent 61 and the second gas generating agent 62 may be gas generating agents of the same type, the same shape, and the same dimensions, or may be gas generating agents of different types, different shapes, and different dimensions. The first combustion chamber 21 needs not be filled with the first gas generating agent 61, and the second gas generating agent 62 may be ignited by the ignition device 3. For example, the ignition device 3 may be in contact with and surrounded by the second gas generating agent 62 without providing the partition wall 5.

The diffuser portion 4 is a cup-shaped member that is attached and thus closes the other end side of the housing 2, and accommodates a filter 7 therein. In other words, the diffuser portion 4 has a bottomed tubular shape, and is disposed and thus its open end faces the second combustion chamber 22. That is, the diffuser portion 4 has a side wall 41 and a closed end 42, and the open end side of the side wall 41 opposite to the closed end 42 is connected to the housing 2. In the example of FIG. 1, the outer diameter of the side wall 41 is substantially the same as the inner diameter of the housing 2, and a part of the side wall 41 on the open end side is accommodated in the housing 2. The open end side of the side wall 41 may be fixed to the housing 2 by crimping, or the diffuser portion 4 and the housing 2 may be welded. The diffuser portion 4 may be formed integrally with the housing 2 by, for example, drawing or the like.

As illustrated in FIG. 1, at least one gas discharge port 43 is formed on the side wall 41 of the diffuser portion 4. In the example of FIG. 1, the gas discharge port 43 includes a first gas discharge port 431 (also called “first gas discharge port group”), a second gas discharge port 432 (also called “second gas discharge port group”), and a third gas discharge port 433 (also called “third gas discharge port group”). The number of the first gas discharge ports 431, the number of the second gas discharge ports 432, and the number of the third gas discharge ports 433 are each one or more. In the present embodiment, the plurality of first gas discharge ports 431, the plurality of second gas discharge ports 432, and the plurality of third gas discharge ports 433 are provided, and the numbers of the first gas discharge ports, the second gas discharge ports, and the third gas discharge ports are equal to each other. The plurality of first gas discharge ports 431, the plurality of second gas discharge ports 432, and the plurality of third gas discharge ports 433 are each formed at equal intervals in the circumferential direction of the diffuser portion 4. The first gas discharge port 431, the second gas discharge port 432, and the third gas discharge port 433 are positioned in this order from the open end side (the side of the second combustion chamber 22) toward the closed end side of the diffuser portion 4, and the opening area (i.e., the diameter) per discharge port increases as the distance from the second combustion chamber 22 increases. Therefore, in the present embodiment, the total opening area of each of the first gas discharge port 431, the second gas discharge port 432, and the third gas discharge port 433 increases in this order. Here, the “total opening area” refers to each of the sum of the opening areas of one or the plurality of gas discharge ports 43 (i.e., each of the sum of the opening areas of the gas discharge ports included in the first gas discharge port group, the sum of the opening areas of the gas discharge ports included in the second gas discharge port group, and the sum of the opening areas of the gas discharge ports included in the third gas discharge port group).

An accommodating space for accommodating the filter 7 is formed inside the cup-shaped diffuser portion 4. At least a part of the filter 7 is accommodated in the accommodating space of the diffuser portion 4. When the combustion gas generated by the gas generating agents 61 and 62 passes through the filter 7, the filter 7 functions as a cooling portion that cools the combustion gas, and filters the combustion gas by filtering combustion residues of the combustion gas.

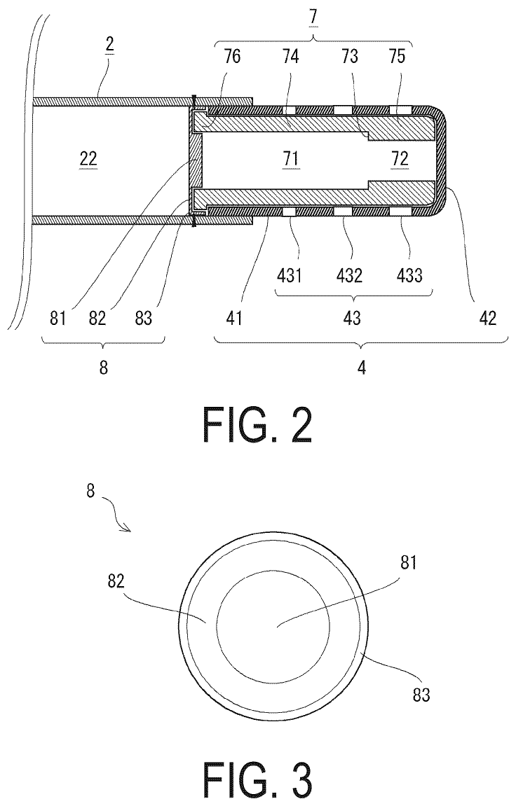

FIG. 2 is a partial cross-sectional view indicating the diffuser portion and a periphery thereof. The filter 7 has a tubular shape whose outer diameter is substantially the same as the inner diameter of the diffuser portion 4, and extends from the side of the open end of the diffuser portion 4 toward the side of the closed end 42. The inside of the filter 7 is provided with a hollow flow path (71 and 72) through which the combustion gas passes. The flow path includes a first section 71 positioned on the open end side of the diffuser portion 4 and a second section 72 positioned on the closed end side of the diffuser portion 4. In the side wall 41 of the diffuser portion 4, a part around the first section 71 in the radial direction (i.e., a region of the side wall 41 corresponding to the first section 71) is referred to as a first side wall region, and a part around the second section 72 in the radial direction (i.e., a region of the side wall 41 corresponding to the second section 72) is referred to as a second side wall region. In other words, of the side wall 41 of the diffuser portion 4, the part around the first section 71 in the radial direction is a part of the side wall 41 positioned on the outer side in the radial direction orthogonal to the axial direction thereof relative to the first section 71. Similarly, of the side wall 41 of the diffuser portion 4, the part around the second section 72 in the radial direction is a part of the side wall 41 positioned on the outer side in the radial direction orthogonal to the axial direction thereof relative to the second section 72. The gas discharge port 431 and the gas discharge port 432 are positioned in the first side wall region, and the gas discharge port 433 is positioned in the second side wall region. The first section 71 and the second section 72 communicate with each other, and the combustion gas can flow into the second section 72 from the first section 71. The inner diameter of the second section 72 is smaller than the inner diameter of the first section 71. Therefore, the filter 7 has a step portion 73 at the boundary between the first section 71 and the second section 72. An end part of the second section 72 on the closed end side of the diffuser portion 4 may be closed by the body of the filter 7, and the flow path needs not penetrate the filter 7. The body portion of the filter 7 includes a first region 74 existing in the radial direction on an outer side of the first section 71 and a second region 75 existing in the radial direction on an outer side of the second section 72. Since the filter 7 has a constant outer diameter, the thickness of the first region 74 is thinner than the thickness of the second region 75.

The filter 7 may be formed by, for example, accommodating, into a molding die, a plain-knitted metal wire material, compression-molding the wire material into a cylindrical shape, and providing through holes corresponding to the first section 71 and the second section 72. The filter 7 may be formed into a columnar shape having a mesh by winding a metal wire rod around a rod-shaped core material formed in the shape of the first section 71 and the second section 72 and thus forming a plurality of layers, and crossing the wire materials with each other. The filter 7 may be a sheet-like perforated plate such as an expanded metal, a punched metal, a metallic lath, a plain-woven wire mesh, or a tatami woven wire mesh is wound up in a cylindrical shape, the plate being provided with through holes corresponding to the first section 71 and the second section 72.

As described above, the filter 7 is a metal filter in which the body portion excluding the first section 71 and the second section 72 is solid and formed in a tubular shape as a whole. The metal is stainless steel, iron, or the like, and may be plated or coated with copper, nickel, or the like. The term “solid” means that a metal material is contained at a predetermined density and thus combustion residues of combustion gas are filtered and the combustion gas is cooled. That is, the combustion gas can pass through not only the above-described flow path but also the first region 74 and the second region 75 of the filter 7 functioning as the cooling portion. However, the combustion gas flows more easily in the first section 71 and the second section 72 than in the first region 74 and the second region 75.

The filter 7 has a flange portion 76 protruding on the second combustion chamber 22 side from the diffuser portion 4 and having an outer diameter larger than the inner diameter of the diffuser portion 4. The flange portion 76 comes into contact with the open end of the diffuser portion 4 in a state where the filter 7 is inserted into the diffuser portion 4. A gap is provided between the flange portion 76 and the housing 2.

The gas generator 1 is provided with a block portion 8 between the second combustion chamber 22 and the diffuser portion 4. The block portion 8 according to the present embodiment is one disk-shaped metal member, and closes the diffuser portion 4 side of the second combustion chamber 22. That is, the diameter of the block portion 8 is substantially the same as the inner diameter of the second combustion chamber 22, and full circumference welding is applied to the housing 2 and the block portion 8 from the outside of the housing 2. In FIG. 2, a welded location is exemplified by a black triangle.

FIG. 3 is a plan view of the block member as viewed from the diffuser portion side. The block portion 8 illustrated in FIGS. 2 and 3 is concentrically provided with three portions having different axial thicknesses of the gas generator 1. As obvious from FIG. 2, a first portion 81 in the center is thicker than a second portion 82 positioned around the first portion 81. The diameter of the first portion 81 is smaller than the inner diameter of the first section 71 and larger than the inner diameter of the second section 72. A part of the first portion 81 on the diffuser portion 4 side is inserted into the first section 71. A third portion 83 positioned around the second portion 82 protrudes on the diffuser portion 4 side and is held between the housing 2 and the flange portion 76 of the filter 7. The first portion 81 is a rupture portion punched out at the boundary with the second portion 82 by the combustion pressure of the gas generating agents 61 and 62 during operation of the gas generator 1. Between the first portion 81 and the second portion 82, a fragile part such as a groove or a notch in which the thickness of the block portion 8 is thinned may be provided partially or over the entire circumference.

The block portion 8 is ruptured in stages depending on an increase in the internal pressures of the first combustion chamber 21 and the second combustion chamber 22 due to the combustion gas. Specifically, when the internal pressure first reaches a first threshold, the block portion 8 is ruptured along the boundary between the first portion 81 and the second portion 82, and the first portion 81 is punched out. The first threshold is a combustion pressure value by the gas generating agent generated during operation of the gas generator 1, and is also referred to as an operation threshold in the present disclosure. Then, the first portion 81 of the block portion 8 moves to the step portion 73 at the boundary between the first portion 81 and the second portion 82 by the flow of the combustion gas.

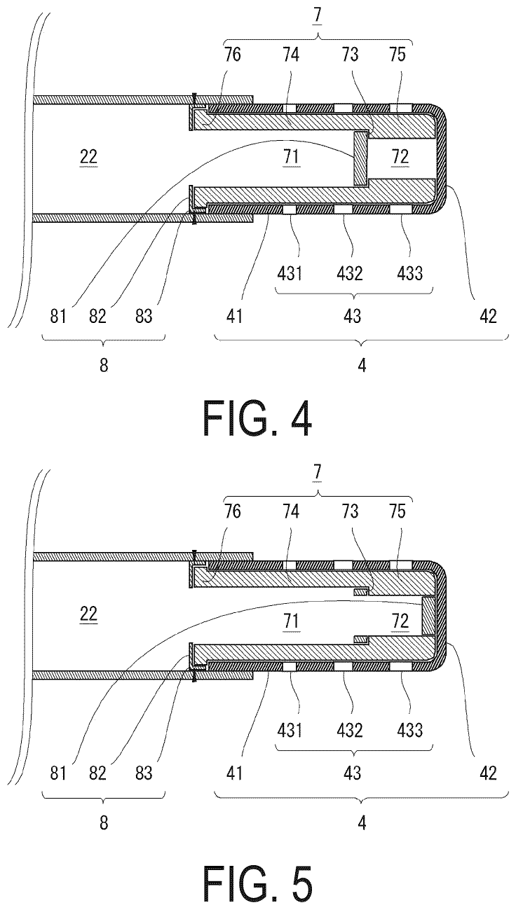

FIG. 4 is a partial cross-sectional view illustrating an example of a state where the block member is ruptured and the first portion is moved. In the state of FIG. 4, the first portion 81 of the block portion 8 closes the inflow of the combustion gas from the first section 71 to the second section 72. The combustion pressure by the gas generating agent gradually increases exceeding the first threshold in a state of room temperature, but is set and thus not exceeds a second threshold described later. Therefore, during operation at room temperature, the first portion 81 is not ruptured and keeps closing the second section. In operation in a high-temperature environment, after the above-described first threshold is generated, the first portion 81 further reaches a pressure equal to or greater than the second threshold, which is larger, and the pressure thereof is applied to the first portion 81. Therefore, the first portion ruptures, and the first section 71 and the second section 72 communicate with each other. The second threshold is also referred to as critical threshold in the present disclosure.

FIG. 5 is a partial cross-sectional view illustrating an example of a state where the first portion of the block member is further ruptured. In FIG. 5, the center of the first portion 81 is further punched out, and a part of the first portion 81 is moved to the closed end side of the diffuser portion 4. The first portion 81 may further include a fragile part (not illustrated) such as a groove or a notch designed to be ruptured by a pressure equal to or greater than the second threshold. It is sufficient that the first portion 81 can break at a pressure equal to or greater than the second threshold to cause the first section 71 and the second section 72 to communicate. For example, as illustrated in FIG. 5, a part of the first portion 81 needs not be punched out, and the entire first portion 81 may be bent and moved to the second section 72. As described above, the block portion 8 is ruptured in stages to close or open between the first section 71 and the second section 72.

### Operation

In a state where the gas generator 1 is assembled to, for example, an airbag of an automobile, a connector (not illustrated) is connected to the pair of electro-conductive pins 32 and 32, and power can be supplied to the ignition device 3. In this state, when a sensor (not illustrated) mounted on an automobile or the like detects an impact, the ignition device 3 is operated by an ignition current supplied to the pair of electro-conductive pins 32 and 32. The ignition device 3 combusts the ignition charge in the cup body 31 and releases the combustion product to the outside of the cup body 31. The first gas generating agent 61 is ignited by flame or combustion gas that is a combustion product of an ignition charge. The first gas generating agent 61 generates combustion gas as a combustion product, and the combustion gas passes through the through hole 54 of the partition wall 5 and ignites the second gas generating agent 62 of the second combustion chamber 22. The second gas generating agent 62 also generates combustion gas as a combustion product.

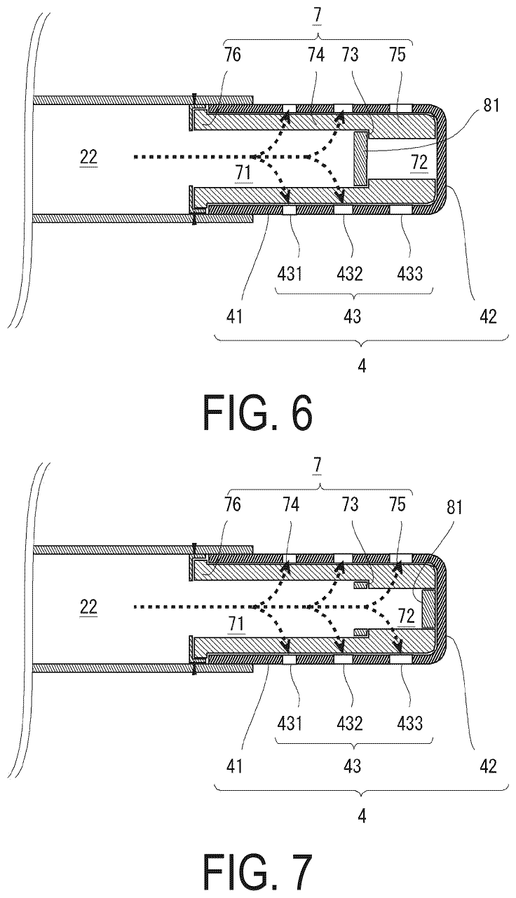

In other words, the example of FIG. 4 described above represents a state when the gas generator 1 operates. FIG. 6 is a view schematically illustrating the flow of the combustion gas in the example of FIG. 4. When the environment in which the gas generator 1 operates is at a predetermined temperature or lower, the reaction speed of combustion of the gas generating agent is relatively low. At this time, the pressure inside the first combustion chamber 21 and the second combustion chamber 22 is designed to exceed the above-described first threshold and increase to a value less than the above-described second threshold. Therefore, at the time point when the pressure of the combustion gas in the first combustion chamber 21 and the second combustion chamber 22 reaches the first threshold, the periphery of the first portion 81 of the block portion 8 is ruptured, and the first portion 81 remains in the step portion 73. Between the first section 71 and the second section 72, the flow of the combustion gas is blocked by the first portion 81 of the block portion 8. Therefore, as illustrated in FIG. 6, the combustion gas passes mainly through the first region 74 of the filter 7, is filtered and cooled, and is discharged mainly from the first gas discharge port 431 and the second gas discharge port 432 of the diffuser portion 4. A part of the combustion gas flows also into the second region 75 of the body portion of the filter 7 and is discharged also from the third gas discharge port 433, but the amount thereof is relatively less. Therefore, since the proportion of the combustion gas passing through the second region 75 is very small, excessive cooling is suppressed.

In other words, the example of FIG. 5 described above represents the operation of the gas generator 1 in an environment at a temperature higher than a predetermined temperature. FIG. 7 is a view schematically illustrating the flow of the combustion gas in the example of FIG. 5. When the environment in which the gas generator 1 operates is at a temperature higher than the predetermined temperature, the reaction speed of combustion of the gas generating agent becomes greater than that in the examples illustrated in FIGS. 4 and 6. The temperature of the generated combustion gas also becomes higher than the temperature of the combustion gas generated during operation at normal temperature. At this time, the pressure inside the first combustion chamber 21 and the second combustion chamber 22 is designed to exceed the above-described second threshold after reaching the first threshold. Therefore, the periphery of the first portion 81 of the block portion 8 is ruptured by the pressure of the combustion gas in the first combustion chamber 21 and the second combustion chamber 22, the first portion 81 of the block portion 8 moves to the step portion 73 of the filter 7, the first portion 81 is further ruptured, and the first section 71 and the second section 72 communicate with each other. Therefore, as illustrated in FIG. 7, the combustion gas passes through the first region 74 and the second region 75 of the filter 7, is filtered and cooled, and is discharged from the first gas discharge port 431, the second gas discharge port 432, and the third gas discharge port 433 of the diffuser portion 4.

### Effects

In general, output of a gas generator varies depending on the environmental temperature during operation. That is, since when the environmental temperature increases, the combustion speed of the gas generating agent increases, and even in a gas generator of the same specifications, the output during operation tends to be great in a high-temperature environment. In the present embodiment, the temperature of the combustion gas generated in the first combustion chamber 21 and the second combustion chamber 22 becomes higher in an operation in an environment of a predetermined temperature or higher (FIG. 7) than in an environment of a temperature lower than the predetermined temperature (FIG. 6). On the other hand, in the example of FIG. 7, since a wider part of the filter 7 can be used as a cooling portion as compared with that of the example of FIG. 6, the cooling efficiency is increased. This also suppresses an increase in the temperature of the combustion gas, and can reduce a difference in the output performance of the gas generators due to a difference in the environmental temperature during operation. In the example of FIG. 6, the region of the filter 7 through which the combustion gas circulates is narrowed, and the cooling of the combustion gas is suppressed as compared with the example of FIG. 7. The combustion gas discharged from the gas generator 1 has a temperature of a mixture of the combustion gas discharged from the first gas discharge port 431, the combustion gas discharged from the second gas discharge port 432, and the combustion gas discharged from the third gas discharge port 433, and according to the gas generator 1 of the present disclosure, a difference in output due to a difference in environmental temperature can be reduced.

### Second Embodiment

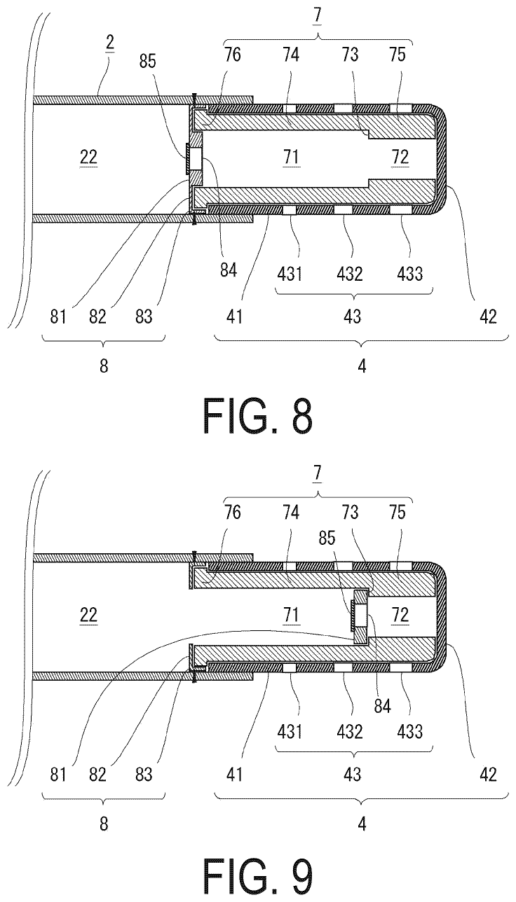

FIG. 8 is a partial schematic axial cross-sectional view illustrating an example of a gas generator according to the second embodiment. In the present embodiment, the block portion 8 is different from that of the first embodiment. Therefore, the same constituent elements as those in the above-described first embodiment are denoted by corresponding reference signs or are not illustrated.

The block portion 8 of FIG. 8 has a through hole 84 in the center of the first portion 81, and the through hole 84 is closed by a seal tape 85. The seal tape 85 is a seal member in which an adhesive layer is formed on one surface of, for example, an aluminum foil or a stainless foil. In the present embodiment, the seal tape 85 is designed to require a greater force for rupturing than the boundary between the first portion 81 and the second portion 82. That is, similarly to the first embodiment, in the block portion 8, when the internal pressure of the first combustion chamber 21 and the second combustion chamber 22 exceeds the first threshold due to the combustion gas, the boundary between the first portion 81 and the second portion 82 is ruptured. The seal tape 85 is ruptured when the internal pressure of the first combustion chamber 21 and the second combustion chamber 22 becomes equal to or greater than the pressure of the second threshold, which is greater than the first threshold, by the combustion gas. The break strength of the seal tape 8 can be adjusted by changing the material and thickness of the seal tape 8, or by overlapping two or more seal tapes 85. In the present embodiment, the strength of the first portion 81, the second portion 82, and the seal tape 85 can be individually designed, which is easy to design.

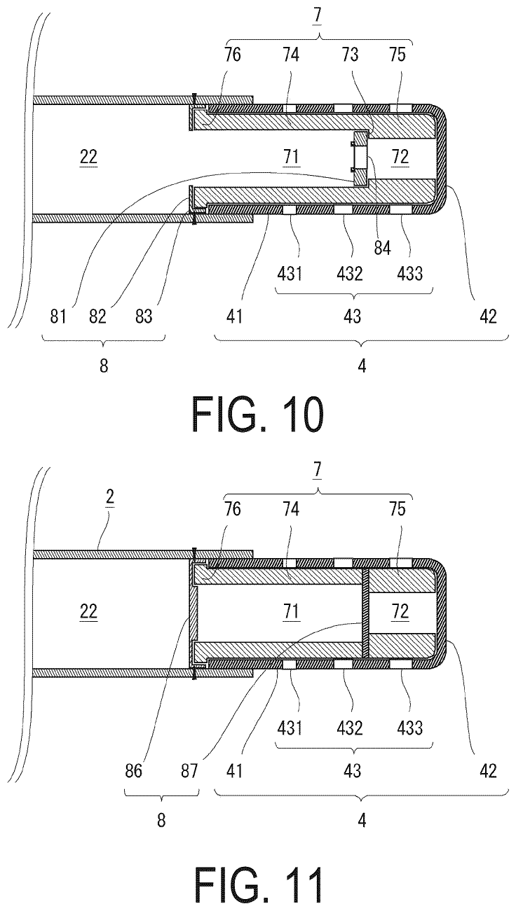

FIG. 9 is a partial cross-sectional view illustrating an example of a state where the block portion is ruptured and the first portion is moved. Also in the present embodiment, when the first portion 81 of the block portion 8 moves to the step portion 73 of the filter 7, inflow of the combustion gas from the first section 71 to the second section 72 is blocked. FIG. 10 is a partial cross-sectional view illustrating an example of a state where the seal tape is further ruptured. Upon receiving a pressure equal to or greater than the second threshold, the seal tape 85 is further ruptured to open the through hole 84, and the first section 71 and the second section 72 communicate with each other. As described above, the block portion 8 is ruptured in stages to close or open between the first section 71 and the second section 72. The gas generator 1 according to the present embodiment can also change, in stages, the size of the part of the filter 7 used as the cooling portion depending on the environmental temperature.

### Third Embodiment

FIG. 11 is a partial schematic axial cross-sectional view illustrating an example of a gas generator according to the third embodiment. In the present embodiment, the filter 7 and the block portion 8 are different from those of the first embodiment and the second embodiment. The same constituent elements as those in the above-described first embodiment and second embodiment are denoted by corresponding reference signs or are not illustrated.

In the present embodiment, the block portion 8 includes a first block member 86 and a second block member 87, which are separate bodies. The first region 74 and the second region 75 of the filter 7 are formed as separate bodies, and the second block member 87 is disposed between them. The first block member 86 is a constituent element corresponding to the block portion 8 in the first embodiment, and is designed to be ruptured when the pressure during combustion exceeds at least a first threshold. In the present embodiment, a part of the first block member 86 to be punched out during rupture is smaller than the inner diameter of the first section 71 and the inner diameter of the second section 72. In the present embodiment, the inner diameter of the first section 71 and the inner diameter of the second section 72 may be the same, or the inner diameter of the second section 72 may be larger than the inner diameter of the first section 71. The second block member 87 is a disk-shaped metal member and is disposed between the first region 74 and the second region 75 of the filter 7. The diameter of the second block member 87 is substantially the same as the inner diameter of the diffuser portion 4, and the diffuser portion 4 and the second block member 87 may be welded from the outside of the diffuser portion 4. The second block member 87 is designed to be ruptured at a pressure equal to or greater than a second threshold, which is greater than the first threshold. Therefore, the block portion 8 according to the present embodiment also is ruptured in stages depending on the pressure, and it makes it possible to sequentially open between the second combustion chamber 22 and the first section 71 and between the first section 71 and the second section 72. Therefore, the gas generator 1 according to the present embodiment can also change, in stages, the size of the part of the filter 7 used as the cooling portion depending on the environmental temperature. The filter 7 may be disposed with the first region 74 and the second region 75 of the filter 7 being in contact with each other, and the filter 7 having an annular groove for holding the second block member 87 between the first region 74 and the second region 75 may be used.

### Fourth Embodiment

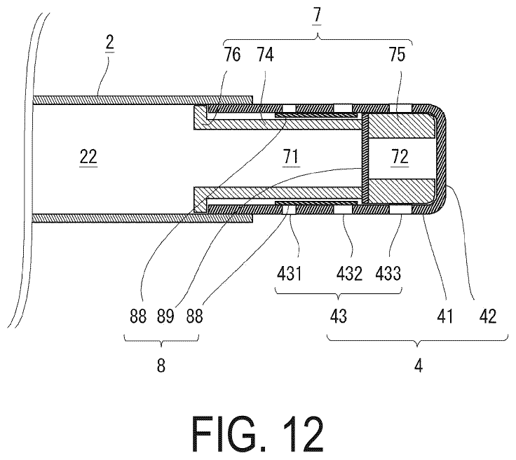

FIG. 12 is a partial schematic axial cross-sectional view illustrating an example of a gas generator according to the fourth embodiment. In the present embodiment, the filter 7 and the block portion 8 are different from those of the other embodiments. The same constituent elements as those in the above-described other embodiment are denoted by corresponding reference signs or are not illustrated.

In the present embodiment, similarly to the third embodiment, the first region 74 and the second region 75 of the filter 7 are formed as separate bodies, and a gap is provided between them. The inner diameter of the first section 71 and the inner diameter of the second section 72 may be the same, or the inner diameter of the second section 72 may be larger than the inner diameter of the first section 71. It is assumed that the second combustion chamber 22 in the housing 2 communicates with the first section 71 of the filter 7, and the first section 71 is also filled with the second gas generating agent 62. The second combustion chamber 22 and the first section 71 may be partitioned by a wire mesh (not illustrated) having a mesh smaller than the second gas generating agent 62, for example, and only the second combustion chamber 22 may be filled with the second gas generating agent 62.

The block portion 8 according to the present embodiment includes a seal tape 88 and a third block member 89. The seal tape 88 according to the present embodiment is also formed by forming an adhesive layer on one surface of an aluminum foil or a stainless foil, for example. The seal tape 88 closes all the gas discharge ports 431 and 432 provided in the radial direction around the first section 71. The seal tape 88 according to the present embodiment is designed to be ruptured when the combustion pressure exceeds the first threshold. The third block member 89 is a member similar to the second block member 87 according to the third embodiment. That is, the third block member 89 is also a disk-shaped metal member and is disposed between the first region 74 and the second region 75 of the filter 7. The diameter of the third block member 89 is substantially the same as the inner diameter of the diffuser portion 4, and full circumference welding is applied to the diffuser portion 4 and the third block member 89 from the outside of the diffuser portion 4. The third block member 89 is designed to be ruptured at a pressure equal to or greater than a second threshold, which is greater than the first threshold.

As described above, in the gas generator 1 according to the present embodiment, the space between the second combustion chamber 22 and the first section 71 is initially opened. The seal tape 88 that closes the gas discharge port 431 and the gas discharge port 432 and the third block member 89 between the first section 71 and the second section 72 are ruptured in stages depending on the pressure, and the gas discharge port 43 is opened. Therefore, the gas generator 1 according to the present embodiment can also change, in stages, the size of the part of the filter 7 used as the cooling portion depending on the environmental temperature.

### Fifth Embodiment

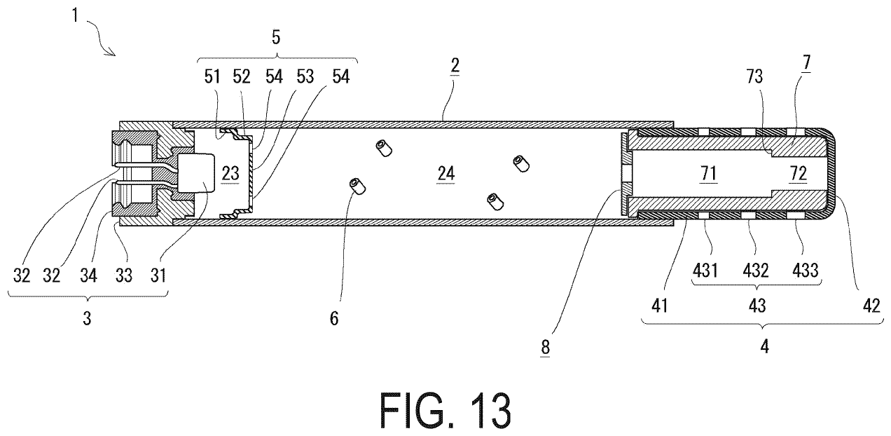

FIG. 13 is a schematic axial cross-sectional view illustrating an example of a gas generation device according to another embodiment. Also in the present embodiment, the same constituent elements as those in the above-described embodiments are denoted by corresponding reference signs or are not illustrated.

In the present embodiment, the block portion 8 is an orifice plate provided with an opening in the center in advance, and are not ruptured in stages depending on the internal pressure of the gas generator 1. Inside the housing 2, a hollow part 23 without a gas generating agent held therein is formed instead of the first combustion chamber 21. That is, the housing 2 is partitioned by the partition wall 5 into the hollow part 23 formed between the ignition device 3 and the partition wall 5 and a combustion chamber 24 formed between the partition wall 5 and the diffuser portion 4.

In the present embodiment, the periphery of the block portion 8 is not in contact with the inner periphery of the housing 2. A crank-shaped boundary is formed between the filter 7 and the housing 2 and the diffuser portion 4 in transverse cross-sectional view. The outer diameter of the block portion 8 is smaller than the inner diameter of the housing 2, and does not include the third portion 83. The outer periphery of the block portion 8 is provided with a gap between the outer periphery of the block portion 8 and the housing 2. Such a block portion 8 may be held between the filter 7 and a gas generating agent 6, or the block portion 8 and the filter 7 may be welded at least partially. When the filter 7 includes a through hole or a recess portion, the first portion 81 of the block portion 8 may be aligned by being inserted into the through hole or the recess portion of the filter 7. It is assumed that the block portion 8 has one or more through holes 84 and is not shielded by a seal member or the like in the present embodiment. In such configuration, the gas generator 1 according to the present embodiment suppresses the combustion gas from being discharged from the gas discharge port 43 of the diffuser portion 4 without passing through the filter 7.

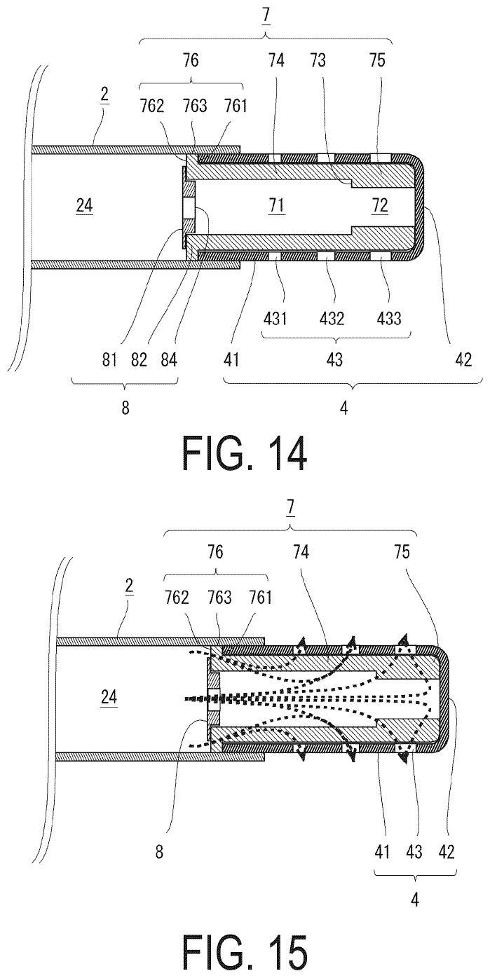

Also in the present embodiment, the filter 7 includes the first region 74 and the second region 75 (the first region 74 and the second region 75 are also collectively called “body portion”), and the flange portion 76. The flange portion 76 of the filter 7 comes into contact with the open end of the diffuser portion 4 in a state where the filter 7 is inserted into the diffuser portion 4. FIG. 14 is a partial cross-sectional view indicating the diffuser portion and a periphery thereof. The flange portion 76 of the filter 7 includes a first annular surface 761 in contact with the open end of the diffuser portion 4 in a state where the filter 7 is inserted into the diffuser portion 4, a second annular surface 762 facing the combustion chamber 24, which is an opposite side to the first annular surface 761, and an annular peripheral surface 763 connecting the first annular surface 761 and the second annular surface 762 and facing the outer peripheral direction.

The first annular surface 761 comes into contact with the open end of the diffuser portion 4. In particular, during operation of the gas generator 1, the combustion gas generated by combustion of the gas generating agent 6 increases the internal pressure of the combustion chamber 24, and the filter 7 is biased in the direction of the diffuser portion 4. At this time, since there is no longer a gap between the first annular surface 761 and the open end of the diffuser portion 4, the combustion gas can be suppressed from being discharged without passing through the filter 7 along the crank-shaped boundary between the filter 7 and the housing 2 and the diffuser portion 4 in transverse cross-sectional view. At least a part of the first annular surface 761 may be welded to the open end of the diffuser portion 4.

The annular peripheral surface 763 may be press-fitted and thus comes into contact with the inner periphery of the housing 2. Also such configuration can suppress the combustion gas from being discharged without passing through the filter 7 along the crank-shaped boundary between the filter 7 and the housing 2 and the diffuser portion 4 in transverse cross-sectional view.

A region along the outer periphery (also called an “outer peripheral part”) of the second annular surface 762 is exposed to the combustion chamber 24 without being covered with the block portion 8. Therefore, the combustion gas enters the filter 7 also from the outer peripheral part of the second annular surface 762. FIG. 15 is a schematic view for explaining a movement path of the combustion gas in the diffuser portion. In FIG. 15, a broken line arrow exemplifies a movement path of the combustion gas in the diffuser portion 4. The combustion gas entering the filter 7 from the outer peripheral part of the second annular surface 762 passes through the filter 7 by a relatively longer distance or a greater number of times than that of the combustion gas passing through the through hole 84 of the block portion 8 and entering the filter 7 from the flow path in the filter 7. Therefore, the cooling efficiency of the combustion gas and filtering effect of combustion residues are enhanced by taking the combustion gas into the filter 7 from the outer peripheral part of the second annular surface 762.

A part of the combustion gas passing through the through hole 84 of the block portion 8 and entering the flow path in the filter 7 collides with the closed end 42 of the diffuser portion 4 to change the direction, passes through the filter 7, and is discharged from the gas discharge port 43. The configuration in which the filter 7 and the closed end 42 of the diffuser portion 4 are in contact with each other suppresses the combustion gas from being discharged without passing through the filter 7 along the boundary between the filter 7 and the closed end 42. The flow speed of the combustion gas increases after passing through the through hole 84 of the block portion 8, which is an orifice plate, and a relatively great amount of combustion gas reaches the closed end 42 of the diffuser portion 4. By making the thickness of the filter 7 thicker on the closed end 42 side than on the open end side of the diffuser portion 4, the cooling efficiency of the combustion gas having reached the closed end 42 and the filtering effect of combustion residues can be improved. In the present embodiment, the flow path formed inside the filter 7 needs not be the through hole but may be a recess portion closed on the closed end 42 side of the diffuser portion 4, or the filter 7 may not have the flow path (71, 72).

In the present embodiment, the housing 2 is partitioned by the partition wall 5 into the hollow part 23 formed between the ignition device 3 and the partition wall 5 and the combustion chamber 24 formed between the partition wall 5 and the diffuser portion 4. The hollow part 23 does not accommodate the gas generating agent, but may be filled with the gas generating agent as in FIG. 1. The combustion chamber 24 holds the gas generating agent 6 therein. The gas generating agent 6 is formed of a known composition and combusts to generate combustion gas. The gas generating agent 6 may be the same as or may be different from the first gas generating agent 61 or the second gas generation 62.

The partition wall 5 functions as a holder (also called “retainer”) that presses, in the direction of the diffuser portion 4, the granular gas generating agent 6 accommodated in the combustion chamber 24, and restricts swinging of the gas generating agent 6. That is, the partition wall 5 is press-fitted into the housing 2, for example, and the large diameter part 51 of the side part of the partition wall 5 functions as a connection portion coming into contact with the inner periphery of the housing 2. The bottom part 53 of the partition wall 5 is a flat plate portion, and presses, in the direction of the diffuser portion 4, the granular gas generating agent 6 accommodated in the combustion chamber 24.

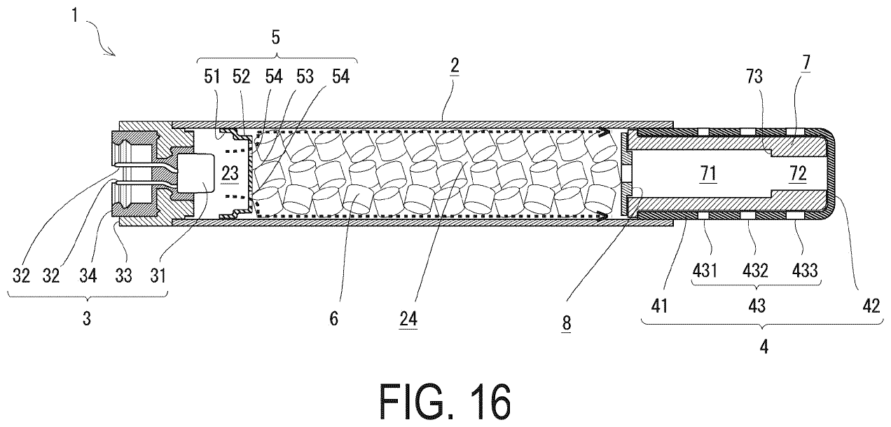

The partition wall 5 does not have the through hole 54 in the center of the bottom part 53 but has the through hole close to the outer periphery. For example, a plurality of the through holes 54 are provided along the outer periphery of the bottom part 53. FIG. 16 is a schematic view for explaining a movement path of the combustion gas in the combustion chamber. The combustion chamber 24 is filled with the granular gas generating agent 6. The gas generating agent 6 has, for example, a cylindrical shape, and gaps are irregularly formed between the gas generating agents 6. The size and shape of the gas generating agent 6 are not limited to those illustrated in the drawings.

When flowing through the combustion chamber 24, the combustion gas meanders the gas generating agent 6 intricately filled, and therefore the path length thereof becomes longer than the length of the housing 2. However, since the inner peripheral surface of the housing 2 and the gas generating agent 6 do not become intricate to each other, a gap extending relatively linearly to the diffuser portion 4 is formed along the inner peripheral surface of the housing 2. Therefore, as indicated by a broken line arrow in FIG. 16, the combustion gas can flow relatively linearly in the axial direction of the housing 2 along the inner peripheral surface of the housing 2. As described above, by providing the through hole 54 close to the outer periphery of the bottom part 53 of the partition wall 5, the combustion product of the ignition device 3 passing through the through hole 54 easily flows along the inner peripheral surface of the housing 2 in the combustion chamber 24, and the time from operation of the gas generator 1 to discharge of the combustion gas can be shortened. In this case, of course, the through hole 54 may coexist also in the center of the bottom part 53.

### Sixth Embodiment

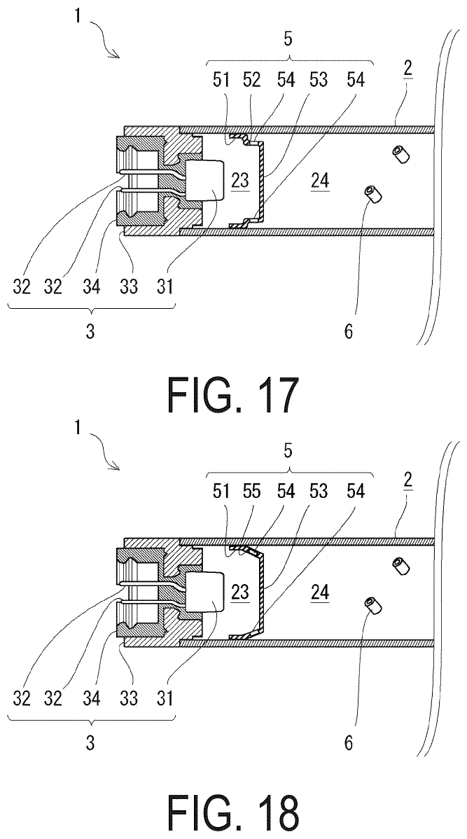

FIG. 17 is a schematic axial cross-sectional view illustrating an example of a gas generation device according to the sixth embodiment that is a variation of the fifth embodiment. Also in the present embodiment, the same constituent elements as those in the above-described embodiments are denoted by corresponding reference signs or are not illustrated.

FIG. 17 illustrates an igniter, a hollow part, and the periphery thereof. The partition wall 5 of the gas generator 1 according to the present embodiment has the through hole 54 in the small diameter part 52 of the side part. The partition wall 5 does not have the through hole 54 in the bottom part 53. With such a partition wall 5, the combustion product of the ignition device 3 is released toward the inner periphery of the housing 2 from the hollow part 23 to the combustion chamber 24. Therefore, the combustion product of the ignition device 3 easily passes through the path along the inner peripheral surface of the housing 2 indicated by the broken line arrow in FIG. 16. That is, the time from operation of the gas generator 1 to discharge of the combustion gas can be shortened. The gas generating agent 6 does not exist in an annular space between the small diameter part 52 and the housing 2. That is, the length between the small diameter part 52 and the housing 2 or the length of the small diameter part 52 in the axial direction of the housing 2 is less than the diameter and height of the gas generating agent 6 having, for example, a cylindrical shape.

### Seventh Embodiment

FIG. 18 is a schematic axial cross-sectional view illustrating an example of a gas generation device according to the seventh embodiment that is a variation of the fifth embodiment. Also in the present embodiment, the same constituent elements as those in the above-described embodiments are denoted by corresponding reference signs or are not illustrated.

FIG. 18 illustrates an igniter, a hollow part, and the periphery thereof. The partition wall 5 of the gas generator 1 according to the present embodiment does not include the small diameter part 52 on the side part thereof, and has the annular inclined surface 55 tapered toward the outer edge of the bottom part 53 from the large diameter part 51. The annular inclined surface 55 has the through hole 54. The partition wall 5 does not have the through hole 54 in the bottom part 53. In also such a partition wall 5, the combustion product of the ignition device 3 is released toward the inner periphery of the housing 2 from the hollow part 23 to the combustion chamber 24. Therefore, the combustion product of the ignition device 3 easily passes through the path along the inner peripheral surface of the housing 2 indicated by the broken line arrow in FIG. 16. That is, the time from operation of the gas generator 1 to discharge of the combustion gas can be shortened. The gas generating agent 6 does not exist in an annular space between the annular inclined surface 55 and the housing 2. That is, the length of the annular space in the radial direction or the axial direction of the housing 2 is less than the diameter and the height of the gas generating agent 6 having a cylindrical shape, for example.

### Others

While the embodiments of the gas generation device according to the present disclosure have been described above, each aspect disclosed in the present description can be combined with other features disclosed in the present description. For example, the first block member 86 and the second block member 87 in FIG. 11 and the third block member 89 in FIG. 12 may each have a through hole and a seal tape that closes the through hole, and the seal tape may be ruptured by receiving a predetermined pressure.

In the embodiments described above, the opening areas of the first gas discharge port 431, the second gas discharge port 432, and the third gas discharge port 433 are larger as the distance from the second combustion chamber 22 increases. Of the side wall of the diffuser portion, the total opening area of the gas discharge ports provided in the second side wall region positioned around the second section 72 may be made larger than the total opening area of the gas discharge ports provided in the first side wall region positioned around the first section 71. When the internal pressure of the gas generator 1 is sufficiently great, the ratio of the amount of combustion gas discharged from each gas discharge port 43 per unit time depends on the ratio of the area of each gas discharge port 43. Therefore, by increasing the opening area of the third gas discharge port 433, in a state where the first section 71 and the second section 72 communicate with each other, the combustion gas can be caused to pass through the second region 75 of the filter 7 as much as possible, and the cooling efficiency can be enhanced. The opening area (diameter) of the individual gas discharge ports 43 provided in the second side wall region may become larger than that of the gas discharge ports 43 provided in the first side wall region, or the number of the gas discharge ports 43 may be increased in the second side wall region by making the opening area (diameter) per discharge port the same. The opening ratio of the gas discharge port 43 with respect to the area of the diffuser portion 4 may become greater in the second side wall region than in the first side wall region. However, the opening area and the shape of the gas discharge port 43 are not limited to those illustrated, and for example, all opening areas may be the same, or the opening ratio of the first side wall region may be greater than that of the second side wall region.

The block portion 8 of the gas generator 1 may be switchable of the region of the filter 7 used as the cooling portion to three or more stages depending on the internal pressure of the combustion chamber. The gas generator 1 may be incorporated in a device other than the airbag.

The first combustion chamber 21 and the second combustion chamber 22 illustrated in the first to fourth embodiments may be applied to the fifth to seventh embodiments, or the hollow part 23 and the combustion chamber 24 illustrated in the fifth to seventh embodiments may be applied to the first to fourth embodiments.

### REFERENCE SIGNS LIST

1 Gas generator
2 Housing
21 First combustion chamber
22 Second combustion chamber
23 Hollow part
24 Combustion chamber
3 Ignition device
4 Diffuser portion
41 Side wall
42 Closed end
43 (431 to 433) Gas discharge port
5 Partition wall
6 Gas generating agent
61 First gas generating agent
62 Second gas generating agent
7 Filter
71 First section
72 Second section
73 Step portion
74 First region
75 Second region
8 Block portion
81 First portion
82 Second portion
83 Third portion
84 Through hole
85 Seal tape
86 First block member
87 Second block member
88 Seal tape
89 Third block member

1. A gas generator comprising:
a housing forming an outer shell container and extending from one end side to the other end side:
an ignition device attached to the housing;
a combustion chamber formed inside the housing and configured to accommodate a gas generating agent ignited by the ignition device;
a diffuser portion provided on the other end side of the housing and including a closed end with an end part being closed and a side wall including a plurality of gas discharge ports;
a filter at least partially accommodated inside the diffuser portion, the filter internally including a hollow flow path directed from a side of the combustion chamber to a side of the closed end, the flow path including a first section including one end connected to the combustion chamber, and a second section connected to the other end of the first section; and
a block portion configured to bring a closed state between the first section and the second section when a combustion pressure of the gas generating agent during operation is less than a predetermined critical threshold, and configured to bring a communication state between the first section and the second section when the combustion pressure is equal to or greater than the critical threshold, wherein
the side wall of the diffuser portion includes a first side wall region positioned around the first section and a second side wall region positioned around the second section, and each of the first side wall region and the second side wall region is provided with one or more of the plurality of gas discharge ports.

2. The gas generator according to claim 1, wherein
the filter includes the second section with an inner diameter smaller than an inner diameter of the first section, and a step portion at a boundary between the first section and the second section,
the block portion closes between the combustion chamber and the first section before operation, has a diameter equal to or smaller than the inner diameter of the first section and larger than the inner diameter of the second section, and includes a rupture portion formed to be punched out at a pressure equal to or greater than an operation threshold less than the critical threshold,
when the combustion pressure is equal to or greater than the operation threshold and less than a critical threshold, the rupture portion is punched out by the combustion pressure and moved to the step portion to close a space between the first section and the second section, and
when the combustion pressure further reaches the critical threshold or greater, at least a part of the rupture portion is moved to the second section beyond the step portion by the combustion pressure, and brings a communication state between the first section and the second section.

3. The gas generator according to claim 1, wherein
the filter includes the second section with an inner diameter smaller than an inner diameter of the first section, and a step portion at a boundary between the first section and the second section,
the block portion closes between the combustion chamber and the first section before operation, has a diameter equal to or smaller than the inner diameter of the first section and larger than the inner diameter of the second section, and includes a rupture portion formed to be punched out at a pressure equal to or greater than an operation threshold less than the critical threshold,
the rupture portion includes a through hole and a seal member configured to close the through hole and be ruptured at a pressure equal to or greater than the critical threshold,
when the combustion pressure is equal to or greater than the operation threshold and less than a critical threshold, the rupture portion is punched out by the combustion pressure and moved to the step portion to close a space between the first section and the second section, and
when the combustion pressure further reaches the critical threshold or greater, the seal member is ruptured by the combustion pressure to open the through hole, and brings a communication state between the first section and the second section.

4. The gas generator according to claim 1, wherein
the block portion includes
a first block member configured to close between the combustion chamber and the first section before operation, and be ruptured at the combustion pressure of an operation threshold less than the critical threshold to cause the combustion chamber to communicate with the first section, and
a second block member configured to close between the first section and the second section before operation, and causes the first section and the second section to communicate when the combustion pressure further exceeds the critical threshold.

5. The gas generator according to claim 1, wherein
the block portion includes
a seal member configured to close the gas discharge port provided in the first side wall region before operation, and be ruptured at the combustion pressure of an operation threshold less than the critical threshold, and
a block member configured to close between the first section and the second section before operation, and cause the first section and the second section to communicate when the combustion pressure further exceeds the critical threshold.

6. The gas generator according to claim 2, wherein
the block portion includes a fragile part in which the block portion is thinned along a shape of the rupture portion.

7. The gas generator according to claim 1, wherein
a total opening area of the gas discharge ports provided in the second side wall region is larger than a total opening area of the gas discharge ports provided in the first side wall region.

8. A gas discharge method performed by a gas generator including
a housing forming an outer shell container and extending from one end side to the other end side,
an ignition device attached to the housing,
a combustion chamber formed inside the housing and configured to accommodate a gas generating agent ignited by the ignition device,
a diffuser portion provided on the other end side of the housing and including a closed end with an end part being closed and a side wall including a plurality of gas discharge ports,
a filter at least partially accommodated inside the diffuser portion, the filter internally including a hollow flow path directed from a side of the combustion chamber to a side of the closed end, the flow path including a first section including one end connected to the combustion chamber, and a second section connected to the other end of the first section, and
a block portion configured to bring a closed state between the first section and the second section when a combustion pressure of the gas generating agent during operation is less than a predetermined critical threshold, and bring a communication state between the first section and the second section when the combustion pressure exceeds the critical threshold,
the side wall of the diffuser portion including a first side wall region positioned around the first section and a second side wall region positioned around the second section, and each of the first side wall region and the second side wall region being provided with one or more of the plurality of gas discharge ports, and
the gas discharge method comprising:
supplying an ignition current to ignite the ignition device and combusting the gas generating agent; and
bringing a closed state between the first section and the second section with the block portion when the combustion pressure is less than a predetermined critical threshold, and bringing a communication state between the first section and the second section when the combustion pressure is equal to or greater than the critical threshold.

9. A gas generator comprising:
a housing in a tubular shape forming an outer shell container and extending from one end side to the other end side;
an ignition device attached to the housing;
a combustion chamber formed inside the housing and configured to accommodate a gas generating agent ignited by the ignition device;
a diffuser portion in a tubular shape inserted into the one end side of the housing and including a gas discharge port; and
a filter including a body portion accommodated in the diffuser portion and a flange portion protruding in a radial direction outward relative to an inner periphery of the diffuser portion at an end portion of the body portion on the housing side, wherein
a first annular surface of a surface of the flange portion, the first annular surface facing the body portion side, comes into contact with an end part of the diffuser portion on the housing side.

10. The gas generator according to claim 9, wherein
the flange portion includes
a second annular surface facing a back side of the first annular surface and
an annular peripheral surface configured to connect the first annular surface and the second annular surface, and
the annular peripheral surface comes into contact with an inner periphery of the housing.

11. The gas generator according to claim 9, wherein
the body portion of the filter includes a recess portion extending along an axial direction of the diffuser portion from the housing side, and
the housing internally includes an orifice plate partitioning the combustion chamber and the recess portion and including a through hole causing the combustion chamber and the recess portion to communicate.

12. The gas generator according to claim 10, wherein
the body portion of the filter includes a recess portion extending along an axial direction of the diffuser portion from the housing side,
the housing internally includes an orifice plate partitioning the combustion chamber and the recess portion and including a through hole causing the combustion chamber and the recess portion to communicate,
an outer diameter of the orifice plate is smaller than an outer diameter of the flange portion, and an outer peripheral part of the second annular surface of the flange portion is exposed to the housing side.

13. The gas generator according to claim 11, wherein
the diffuser portion includes a closed end with an end part being closed on an opposite side to the housing, and
the filter comes into contact with the closed end, the recess portion of the filter is a through hole, and a thickness of the filter is thicker on the closed end side than on the housing side.

14. The gas generator according to claim 9, the gas generator comprising:
a retainer configured to partition a space in which the ignition device is disposed and the combustion chamber, and including an opening, the retainer holding the gas generating agent in the combustion chamber, wherein
the ignition device is attached to the other end side of the housing,
the retainer includes a flat plate portion supporting the gas generating agent, a connection portion provided on an outer periphery of the flat plate portion and coming into contact with an inner periphery of the housing, and a through hole in a peripheral edge portion of the flat plate portion.

15. The gas generator according to claim 9, the gas generator comprising:
a retainer configured to partition a space in which the ignition device is disposed and the combustion chamber, and including an opening, the retainer holding the gas generating agent in the combustion chamber, wherein
the ignition device is attached to the other end side of the housing, and
the retainer includes a flat plate portion supporting the gas generating agent, a step portion provided along an outer periphery of the flat plate portion separately from an inner periphery of the housing, a connection portion coming into contact with the inner periphery of the housing, and a through hole in the step portion.

16. The gas generator according to claim 9, the gas generator comprising:
a retainer configured to partition a space in which the ignition device is disposed and the combustion chamber, and including an opening, the retainer holding the gas generating agent in the combustion chamber, wherein
the ignition device is attached to the other end side of the housing, and
the retainer includes a flat plate portion having an outer diameter smaller than an inner diameter of the housing and supporting the gas generating agent, a connection portion coming into contact with an inner periphery of the housing, an annular inclined surface tapered from an outer periphery of the flat plate portion to the connection portion, and a through hole in the annular inclined surface.

17. The gas generator according to claim 3, wherein
the block portion includes a fragile part in which the block portion is thinned along a shape of the rupture portion.

18. The gas generator according to claim 2, wherein
a total opening area of the gas discharge ports provided in the second side wall region is larger than a total opening area of the gas discharge ports provided in the first side wall region.

19. The gas generator according to claim 3, wherein
a total opening area of the gas discharge ports provided in the second side wall region is larger than a total opening area of the gas discharge ports provided in the first side wall region.

20. The gas generator according to claim 10, wherein
the body portion of the filter includes a recess portion extending along an axial direction of the diffuser portion from the housing side, and
the housing internally includes an orifice plate partitioning the combustion chamber and the recess portion and including a through hole causing the combustion chamber and the recess portion to communicate.
